(19) United States
(12) Patent Application Publication
(10) Pub. No.: US 2025/0067409 A1
(43) Pub. Date: Feb. 27, 2025

(54) MODULAR LIGHTING

(71) Applicant: Kuzco Lighting LLC, Las Vegas, NV (US)

(72) Inventors: Nathan Yang, Surrey (CA); Ryan Pauly, New Rochelle, NY (US)

(21) Appl. No.: 18/807,837

(22) Filed: Aug. 16, 2024

Related U.S. Application Data
(60) Provisional application No. 63/533,887, filed on Aug. 21, 2023.

(51) Int. Cl. F21S 8/04; F21S 2/00; F21V 21/03; F21V 21/26; F21V 23/06; F21Y 115/10

(52) U.S. Cl. CPC F21S 8/046; F21S 2/005; F21V 21/03; F21V 21/26; F21V 23/06; F21Y 2115/10

(57) ABSTRACT

Disclosed here are systems and methods for improved modular lighting systems wherein a hub is anchored to a surface with a power supply, one or more bars or arms are attached by friction fit or magnet to the hub, wherein the one or more arms are attached to one or more sub-hubs by friction fit, wherein the one or more sub-hubs are attached to additional arms, wherein one or more of the arms include LED lighting strips, wherein one or more sub-hubs include LED lighting.

### CROSS-REFERENCE TO RELATED APPLICATION

This application relates to and claims priority from U.S. Provisional Application No. 63/533,887 filed on Aug. 21, 2023, the entirety of which is hereby incorporated by reference.

### TECHNICAL FIELD

This application relates to the field of lighting and lighting fixtures and/or interaction between the component parts of a lighting fixture assembly.

### BACKGROUND

Previously, lighting fixtures suffered from inherent drawbacks based on their inability to adapt, change, swap, or customize easily. Such lighting arrangements did not allow for customized arrangements to fit individualized needs. Therefore, supply chains and logistics suffered. There is a great need for a modular, customizable lighting system for interior or exterior of the home or office.

### SUMMARY

Systems and methods here include improved modular lighting systems wherein a hub is anchored to a surface with a power supply, one or more arms are attached by friction fit to the hub, wherein the one or more arms are attached to one or more sub-hubs by friction fit, wherein the one or more sub-hubs are attached to additional arms, wherein one or more of the arms include LED lighting strips, wherein one or more sub-hubs include LED lighting.

Systems and methods here include a modular lighting system, including a hub in communication with a power supply, the hub including a surface anchor unit, a first port and a second port, and in some examples, additionally or alternatively, the hub first port and hub second port configured to conduct power. In some examples, additionally or alternatively, the hub first port and hub second port configured to pivot relative to each other, a first bar with a first end and a second end, the first end of the first bar modularly attached to the first hub port by friction fit or magnet, a second bar with a first end and a second end, the first end of the second bar modularly attached to the second hub port by friction fit or magnet, a first subhub with a first subhub port configured to conduct power, the first subhub port modularly attached to the second end of the first bar by friction fit or magnet a second subhub with a second subhub port configured to conduct power, the second subhub port modularly attached to the second end of the second bar by friction fit or magnet.

In some examples, additionally or alternatively, the hub includes an LED light. In some examples, additionally or alternatively, the first subhub includes an LED light powered by the power supply via the first hub port, the first bar, and the first subhub port. In some examples, additionally or alternatively, the second subhub includes an LED light powered by the power supply via the second hub port, the second bar, and the second subhub port. In some examples, additionally or alternatively, the first bar includes an LED light powered by the power supply via the first hub port. In some examples, additionally or alternatively, the second bar includes an LED light powered by the power supply via the second hub port. In some examples, additionally or alternatively, the first subhub includes a surface anchor unit. In some examples, additionally or alternatively, the second subhub includes a surface anchor unit. In some examples, additionally or alternatively, the first light bar includes a nested rod power connection. In some examples, additionally or alternatively, the hub includes a pivotable power connection in the surface anchor unit, configured to allow the hub to pivot relative to the surface and maintain power connection to the power source. In some examples, additionally or alternatively, the hub surface anchor unit includes multiple annular power connections and one central power connection. In some examples, additionally or alternatively, the multiple annular power connections are negative connections and the one central power connection is a positive connection.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1 is an example diagram of the modular lighting mounted to a surface in accordance with embodiments described herein;

FIG. 2 is an example top down view of the modular lighting in accordance with embodiments described herein;

FIG. 3 is an example diagram of a singular embodiment of modular lighting in accordance with embodiments described herein;

FIG. 4 is an example top down view of the singular embodiment of modular lighting in accordance with embodiments described herein;

FIG. 5 is an example exploded view diagram of a light of the modular lighting in accordance with embodiments described herein;

FIG. 6 is an example exploded view diagram of a connection in the modular lighting in accordance with embodiments described herein;

FIG. 7 is an example exploded view diagram of a connection of the modular lighting in accordance with embodiments described herein;

FIG. 8 is an example exploded view diagram of a connection of the modular lighting in accordance with embodiments described herein;

FIG. 9 is an example exploded view diagram of a connection of the modular lighting in accordance with embodiments described herein;

FIG. 10 is an example diagram of a light of the modular lighting in accordance with embodiments described herein;

FIG. 11 is an example exploded view diagram of multiple connections of the modular lighting in accordance with embodiments described herein;

FIG. 12 is an example diagram of a pivot and mount of the modular lighting in accordance with embodiments described herein; and

FIG. 13 is an example exploded view diagram of a mount of the modular lighting in accordance with embodiments described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the disclosures to these particular embodiments.

### Overview

The modular lighting system embodiments described here include various features for a lighting hub, arms, and sub hubs, the interaction between the hubs, arms and sub hubs and the structures used to hold or dock them together. Some embodiments include features used to pivot the arms around the hubs and the sub hubs in order to configure them into various overall shapes. Any kind of swapping, changing, or alternating parts may be used to configure an endless array of lighting arrangements using the modular component parts described herein. This design reduces product development time, minimizes replacement parts, minimizes packaging, reduces shipping, drives down maintenance, and expands possibilities for design at the same time.

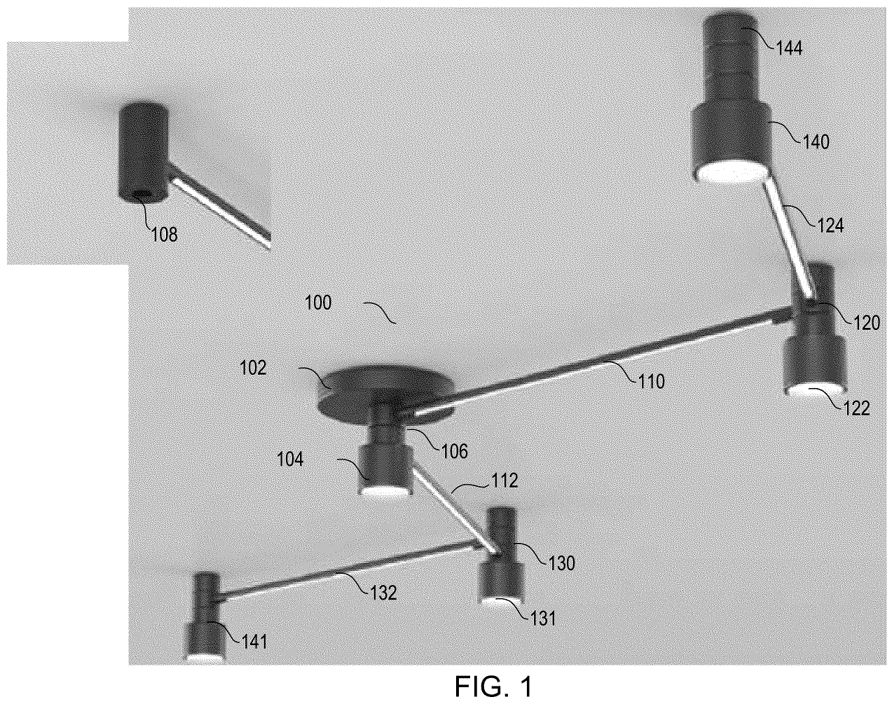

FIG. 1 shows a perspective view of an example modular lighting system mounted on a ceiling 100. FIG. 1 shows a main hub 102 which may be secured to a surface such as a ceiling 100. Such surface securing is described in later figures such as 12 and 13. Such a surface 100 could be a ceiling, wall, or flat piece that a user or design would want to adhere a light structure to in order to provide light. In the example, the main hub 102 includes a wired power and control connection such as that used in a traditional lighting system. In such an example, the main hub 102 is wired to a switch and power so that if the switch (not shown) is turned on, it energizes the circuit which starts with the main hub 102 and any other connected elements as described herein. However, other arrangements may be used to power and control the system, including but not limited to a battery, wireless control, and/or by wire in a traditional lighting system. The main hub 102 in the example may include multiple connection ports that may be used to connect any number of various arms as described herein. The number of connection ports and thereby the number of arms that may be connected to the main hub 102 is only limited by the number of connection ports built into the main hub 102. In the example of FIG. 1, there are two but more or fewer could be arranged in the main hub 102 if they are stacked or built into the main hub 102 as described.

Additionally or alternatively, any number of computer chips or circuit boards may be mounted in and/or connected to the main hub 102. In such examples, the circuitry could be used for timing of turning lights on or off, dimming, light color changes, LED control, motion sensing, etc. Any number of computer programmable functions could be included in such examples that use computer chips or circuit boards in the main hub 102.

In the example of FIG. 1, the main hub 102 includes a pivoting structure 106 which may include connection ports, and also in this example, a hub light 104.

The hub light 104, and all lights described in this disclosure may be any number of lights including but not limited to Light Emitting Diodes (LED), fluorescent bulbs, incandescent bulbs, or any other kind of light source that is powered.

Additionally or alternatively, the main hub 102 may be a hub without a light as shown in the example 108. Either option is available to assemble as described herein, with a light source 104 or without 108 in any of the hubs or sub hubs described herein, in any combination or permutation.

The main hub 102 in the example is connected to two arms 110 and 112 by the connection ports as described herein. These arms may be of any length and may be connected to the main hub 102 by connection ports that may include pivoting structure as described herein. Any number of arms may be mounted into a hub, depending on how many connection ports the hub includes. These arms 110 and 112 as with all arms described in the disclosure, may include their own light source such as but not limited to an LED strip. In such a way, the arms may be able to provide light through its own LED strip or not, depending on the configuration created by a user or designer as described herein. These arms and their own light sources may be independently operated from the hub and sub hub lights 104.

In the example of FIG. 1 the main hub 102 is connected to two arms. This is merely an example and could be any number including but not limited to one, two, three, four, five, six, seven, or any other number of arms. Each arm may be connected to its own connection port which may include a pivoting portion 106 to the main hub 102 from which it draws power and commands to turn on/off as described herein.

In the example of FIG. 1 each of the two arms 110 and 112 attached to the main hub 102 also connect at their respective other ends to respective sub hubs 120 and 130. In this way, each arm 110 and 112 continues the overall structure out and away from the main hub 102 as long as the length of the arm to a sub hub 120, 130 which may or may not include its own light such as but not limited to an LED light 122, 131.

Each sub hub 120, 130 may also be attached to the mounting surface just as the main hub 102 may be attached. In such a way, the overall lighting system may be secured to the surface and hold steady. The arms on each of the main hub 102 and sub hubs 120, 130 may include a pivoting structure with their own respective connection ports. In such a way, each of the hubs and sub hubs may be arranged and rearranged as described herein.

In the example of FIG. 1, each sub hub 120 and 130 has its own additional arms 124 and 132 which in turn each connect to their own additional sub hubs 140, 141. Again, these sub hubs 140 and 141 may be secured to the surface as described herein. Also, these arms 124 and 132 may or may not include their own lights such as but not limited to LED light strips, in any combination or permutation.

Thus, in the example of FIG. 1, a main hub 102 supports a first arm 110 which connects to its own sub hub 120 which connects to another arm 124 which connects to its own sub hub 140 and the main hub 102 also connects to a second arm 112 which itself connects to its own sub hub 130 and that connects to its own arm 132 and then another sub hub 141. In this example, one main hub connects a total of four additional sub hubs with four arms. It should be noted that this configuration and number of arms and sub hubs is only an example and not intended to be limiting in any way. As described herein, a user or designer may connect any number of arms to a main hub or sub hub, thereby creating any number of combinations of arms and sub hubs reaching out to any of various patterns or shapes as described herein.

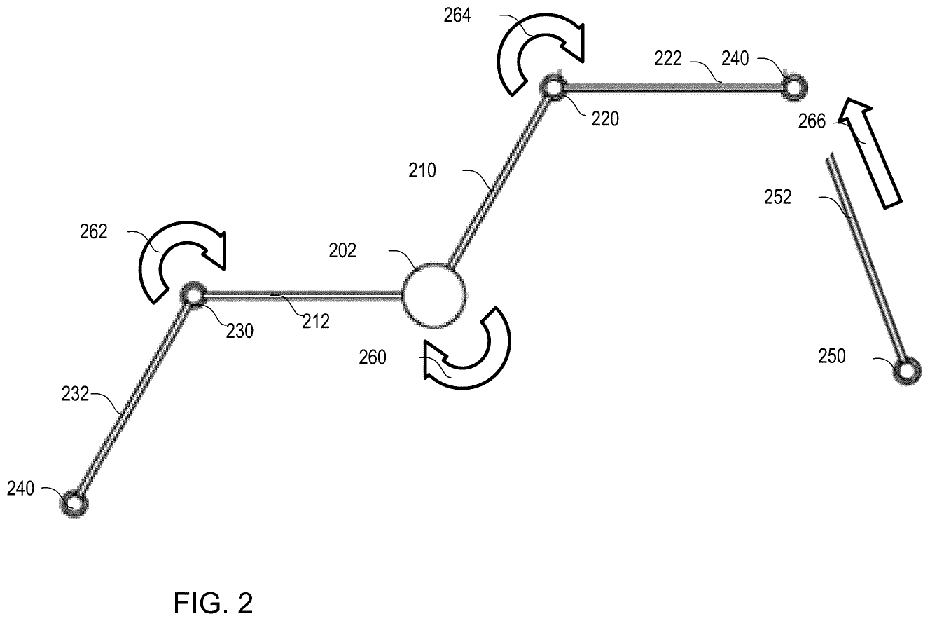

FIG. 2 is a top down or bottom up view of FIG. 1. In the example of FIG. 2, the main hub 202 is again shown connected to two arms 210 and 212 and the arrow 260 shows that either arm could be rotated independently about the main hub 202 as a pivot or axis point. These connections are by connection ports in the hubs and sub hubs and are mounted on pivotable stacked portions of the hubs and sub hubs. Such an arrangement allows for the hubs and sub hubs to be moved such that their respective connection ports are pointed in different directions, and thereby the arms that mount into the connection ports are able to be moved in different directions as shown. Any number of directions may be configured as the pivotable portions with the connection ports may be twisted or moved in a full 360 degree range of motion. This allows for maximum number of directions and reconfigurations for the hub and sub hub connection ports and thereby arms.

The same is shown with the first set of sub hubs 230 and arm 232 which may be rotated independently in any configuration 262 around sub hub 230. Also, the second set of sub hubs 220 and arm 222 which may be rotated independently in any configuration 264 around sub hub 220. One of the arms 222 in shown connected to a sub hub 240 anchored to a surface mount. The other end arm 232 is also shown connected to its own sub hub 240 which may be anchored or mounted to a surface as described herein.

In the example of FIG. 2, an additional arm 252 and its own sub hub 250 are shown connecting to the last sub hub 240 to be mounted and extend the light structure even further than is shown for example in FIG. 1. This is another mere example to show that any number of combinations of connecting arms and sub hubs may be supported and customized in the modular lighting system described herein.

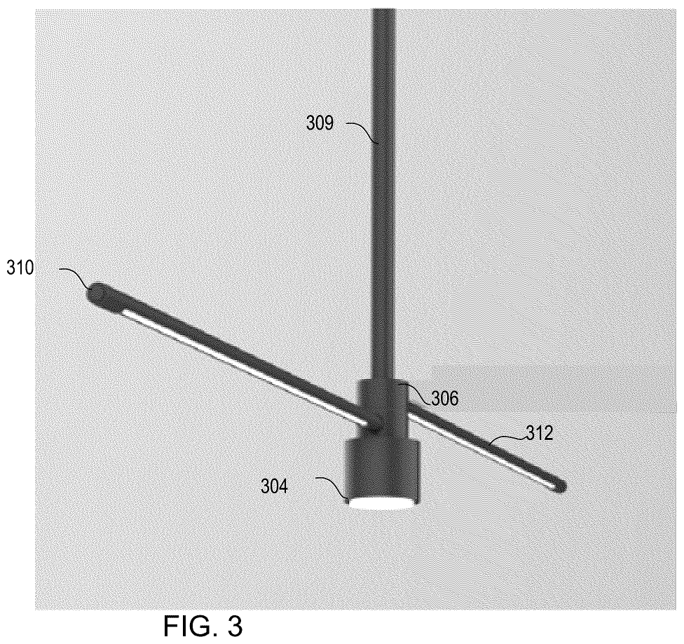

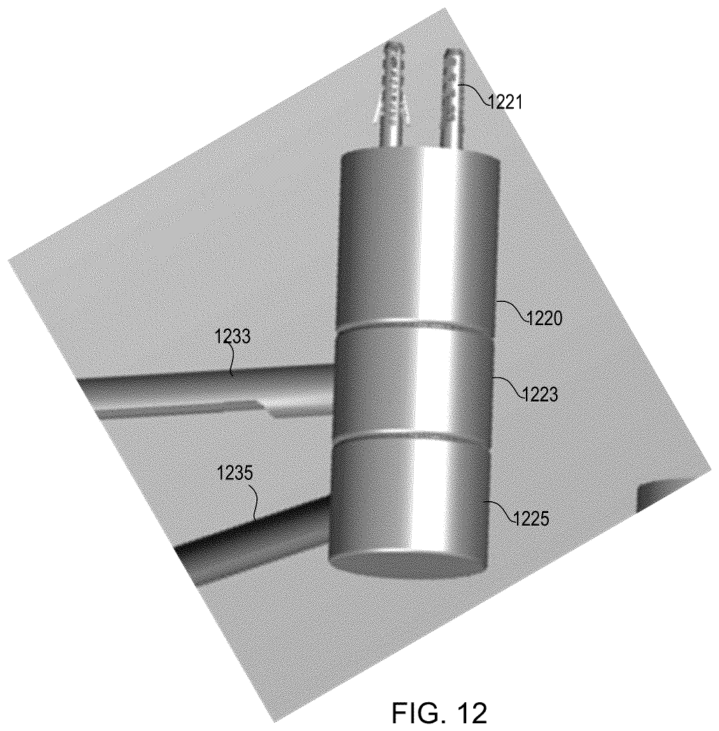

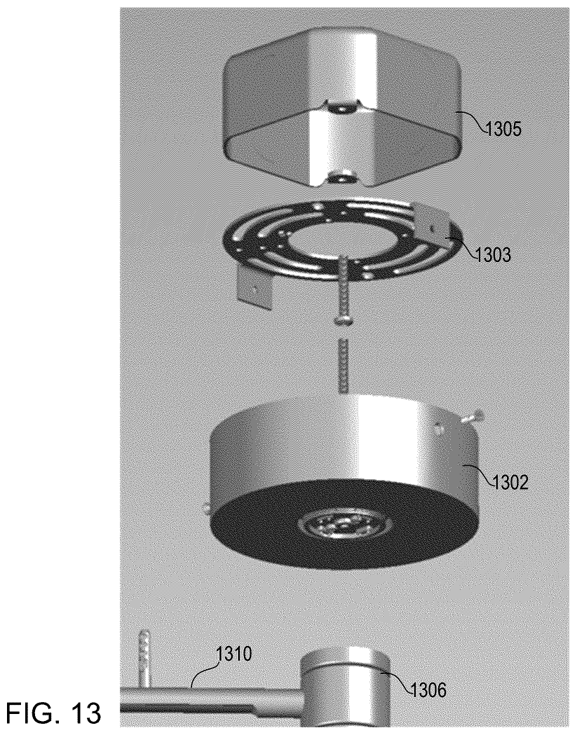

FIG. 3 shows an example embodiment where the main hub 302 is not mounted directly to a surface, but rather by a vertical arm 309. The vertical arm 309 may also allow pivoting of the main hub 302 and provide any wiring necessary for control or operation of the light system as described herein. Such an arm may be secured, anchored or otherwise attached to a surface as described herein, for example in FIGS. 12 and 13.

In such a way, the main hub 302 may be suspended from the surface and provide light itself 304 through its own light source, and/or by one or more arms 310 and 312 shown as an example in FIG. 3. In such a way, similar to the descriptions of FIGS. 1 and 2, any number of configurations may be created with hubs, arms, sub hubs etc. in a suspended arrangement like that of FIG. 3. As described herein additionally or alternatively, the arms 310 and 312 may include their own light source such as LED light bar. In the example, the main hub #306 includes its own light source 304. The hub 306 may have the connection ports mounted statically or in pivotable configurations as described herein. In such a way, the arms 310 and 312 may be moved, pivoted, twisted, or otherwise configured in up to a 360 degree position thereby allowing for customized lighting arm permutations. Any number of arms may be mounted to such a hub 306 and two in the example is merely a non-limiting example. There could be one, two, three, four, five, six, seven, eight, or more arms mounted to a hub as described herein.

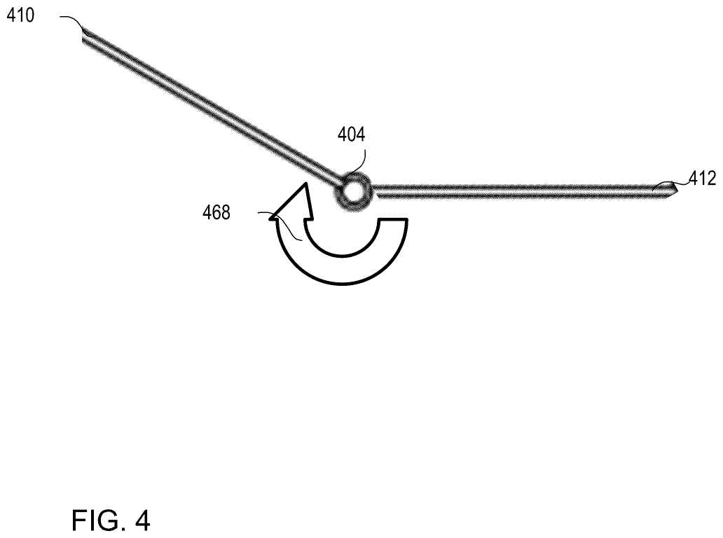

FIG. 4 is a top down or bottom up view of the system of FIG. 3. In the example of FIG. 4 the main hub 402 has two arms 410 and 412 which may pivot around the main hub 402 independently of one another as shown by the arrow 468 as described herein. Each of these arms 410 and 412 may include their own LED strip and the main hub 402 may or may not include its own light such as an LED light as described herein. Again, any number of arms may be attached to a hub in such a way, the example of two arms is not intended to be limiting.

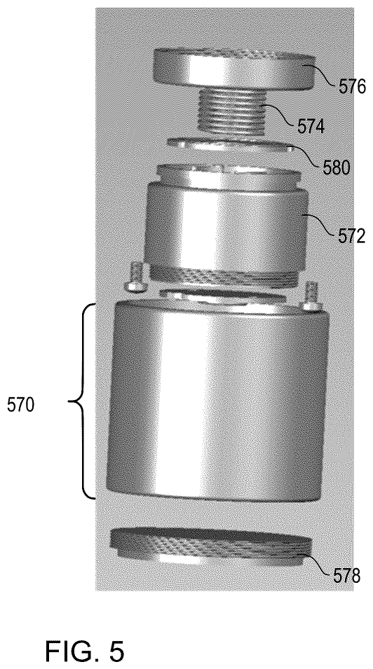

FIG. 5 shows a detail exploded view of one of the hubs or sub hubs described herein. In the example, a main body 570 houses various parts that fit inside it and allow for the modularity, pivotability, and customization of the overall lighting system as described herein. The example of FIG. 5 shows a bottom cap 578 with a screw arrangement that fits inside the main body 570, mates with it and allows for the bottom cap 578 to be screwed into the main body 570 by screw threads. Other securing systems could be used instead of screw threads such as a slot and pin system, friction fit, or other arrangement. In some examples, additionally or alternatively, 578 is an optical lens choice.

The example shows a light housing 572 with a top cap 580 and a spring 574. When mounted together, the spring pushes the light housing 572 down toward the bottom cap 578 to ensure it is pressed down through the main body 570 and the top side 576. This ensures an electrical or power connection as described in the examples herein.

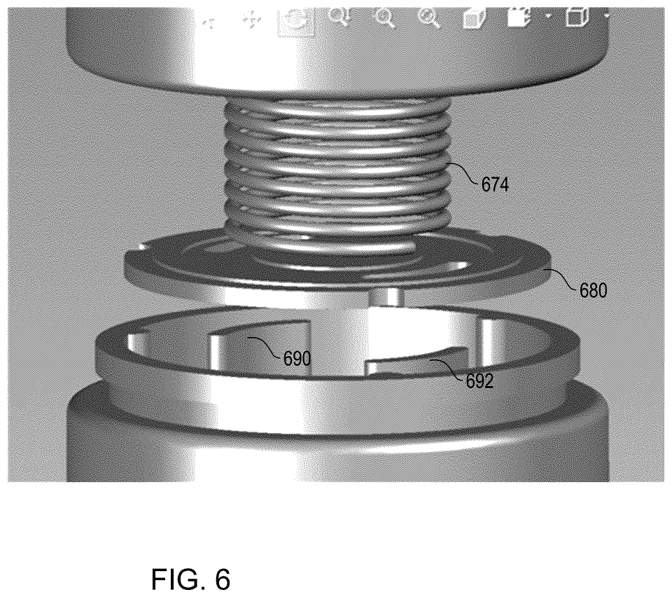

FIG. 6 shows a detail exploded view of the hub with a compression spring 674, top cap 680, and two connectors 690, 692. When assembled, the connectors 690 and 692 fit through corresponding slots in the top cap 680 to allow electrical or power connection through to the other side.

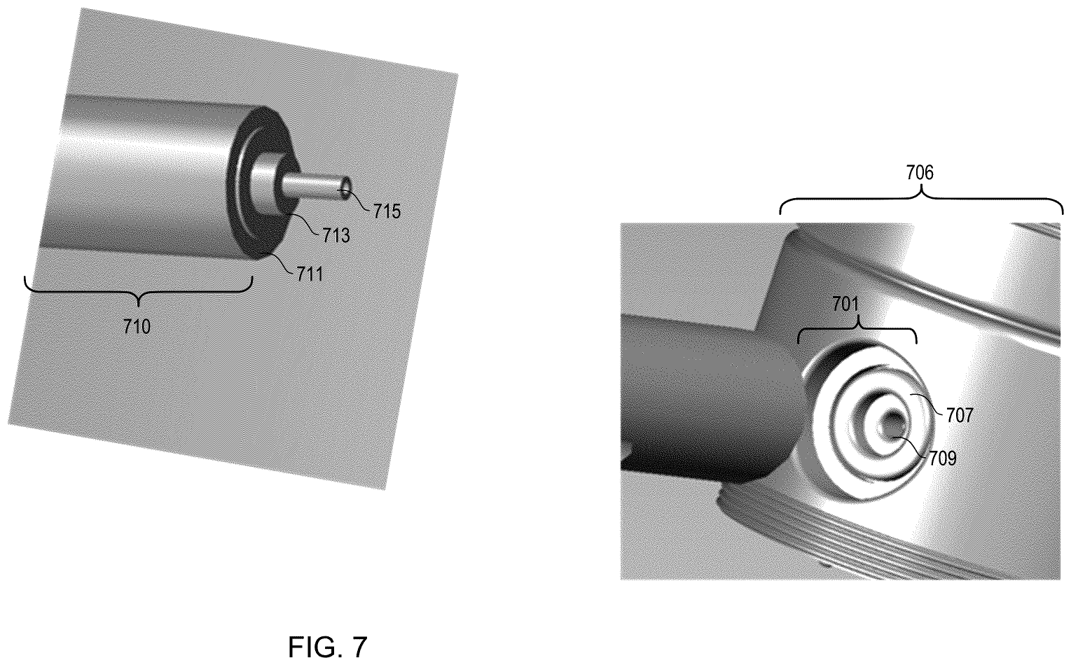

FIG. 7 shows an example connection assembly of a modular light rod 710 with a periphery 711, an exterior electrical or power connector 713 and an interior electrical or power connection 715. In the example, these are all shown as nested rods with diminishing radii such that the interior electrical connection 715 has the smallest radii as compared to the exterior electrical connector 713 and the periphery 711 of the lighting assembly 710.

FIG. 7 also shows a connection port 701 in the hub 706. This connection port 701 may be mounted in the main hub such that it cannot move, or the main body may be able to pivot as described herein. As the connection port 701 pivots in the hub 706, it is able to angle the respective light bar 710 in any direction relative to the hub 706 as described herein.

When assembled into a hub 706, the parts of the lighting arm or rod 710 mate with corresponding parts of the hub connection port 701. For example, the interior electrical connector 715 acts as a male connector when it mates with corresponding female end 709 in the hub 706. The exterior electrical connector 713 mates with the hub connector 707. In some examples, additionally or alternatively, this may be a friction fit. In some examples this may include a magnetic connection with one element including magnets that attract magnets in the other element. In some examples it may be a screw fit. In some examples it may be a turn and twist friction fit. Any of the above example connection fits alone or in any combination may be used to mate the hub connection ports with the arms as described herein.

In example embodiments, electricity may flow through the hub 706 to the lighting rod by these connections. In some examples, additionally or alternatively, some or both of these connectors may be spring mounted such that the interior electrical connector 715 and exterior electrical connector 713 may compress into the lighting rod 710 when pushed into the socket mount on the hub 706. Such a connection may allow for spring pressure to push the corresponding parts together to allow for a good electrical connection. In some examples, additionally or alternatively, insulating material may be mounted such that the interior electrical connector 715 and exterior electrical connector 713 are insolated from one another and allow for activation of any light component in the light rod 710.

In some examples, additionally or alternatively, 713 and 715 are coaxial male/female pin and receptable, with a diameter for receptacle about ⅜ inches. Other example diameters could be used for example, ½ inch, ¾ inch, ¼ inch, 1 inch or any other diameter that would be able to support the light assemblies 710.

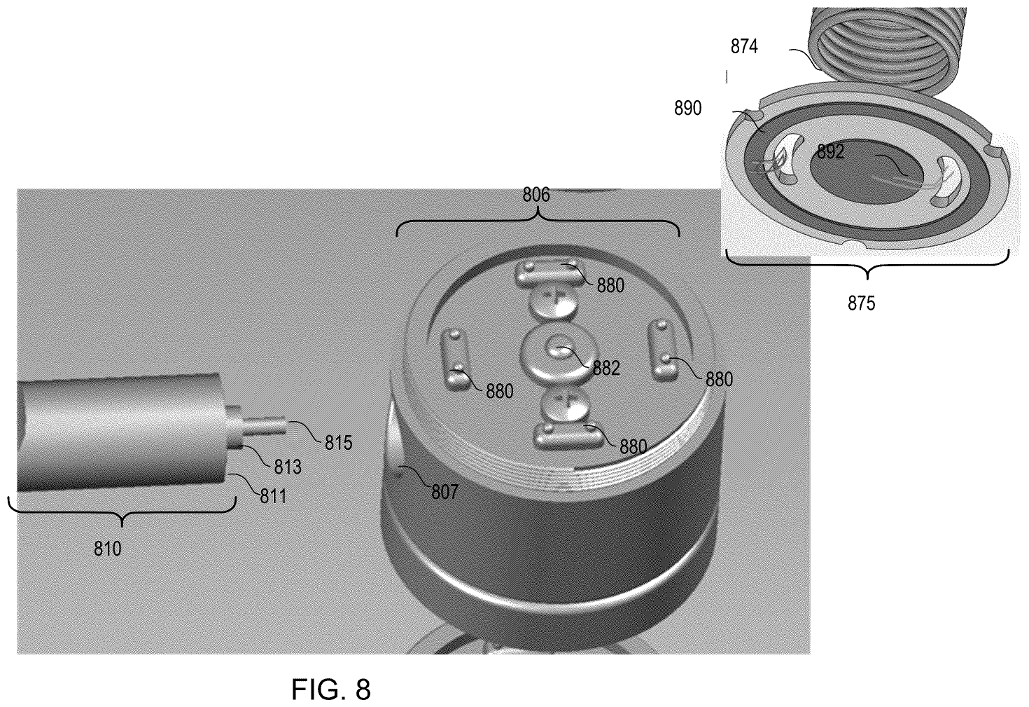

FIG. 8 shows another angle of the light rod 810 and the hub 806 with the connection port on the hub 807 lined up to receive the male connectors 815, 813, 811.

In the example FIG. 8, the hub 806 is shown with a screw top 809 inclined plane configured to screw into other mounting components as described. FIG. 8 also shows the electrical connections on the hub 806. The electrical connections in the hub 806 allow for the hub 806 to rotate or pivot up to a full 360 degree range and still maintain electrical connection. It is by this arrangement that the system may be configured to direct the connection ports 807 and thereby the mounted light arms 810 in any direction around the hub 806 or sub hub. Such an arrangement may be stacked onto a second or third or fourth or any number of configurations such that each may independently pivot in different directions while still maintaining an electrical connection as described.

In the hub 806, the negative connections 880 are shown in this example in four pairs in an annular format surrounding the positive connection 882 located in the center of the hub 806. These electrical connections may then connect the light elements as described herein to power and/or control such lights including those in the arms 810 and/or the hub 806 itself. Additionally, in the format shown, with the pairs of annular negative connections and one central positive connection, a screw type connector may be used to connect as indicated herein. The arrangement prevents a misalignment or the need to align connectors as they are immediately aligned when the parts align. The other side of the electrical connection is also shown in the figure FIG. 8. In the example, the plate 875 to which the connectors may make the electrical connections with an outer ring 890 to mate with and connect to the negative connectors 880 and an inner circle 892 to mate with and connect to the positive connector 882. These annular arrangements allow for the plate 875 and hub 806 to pivot relative to one another, screw together, and/or otherwise mate and electrically connect.

In some examples, additionally or alternatively, a spring may be mounted into the connector leads 880, 882 in order to provide a force that pushes the connector onto the other mated connection side. In such examples, the connectors push against the other side when mounted, thereby ensuring a secure electrical connection. In some examples, additionally or alternatively, a spring 874 may be mounted above the connection plate 875 to press the plate connectors 890 and 892 to the hub connectors 880 and 882.

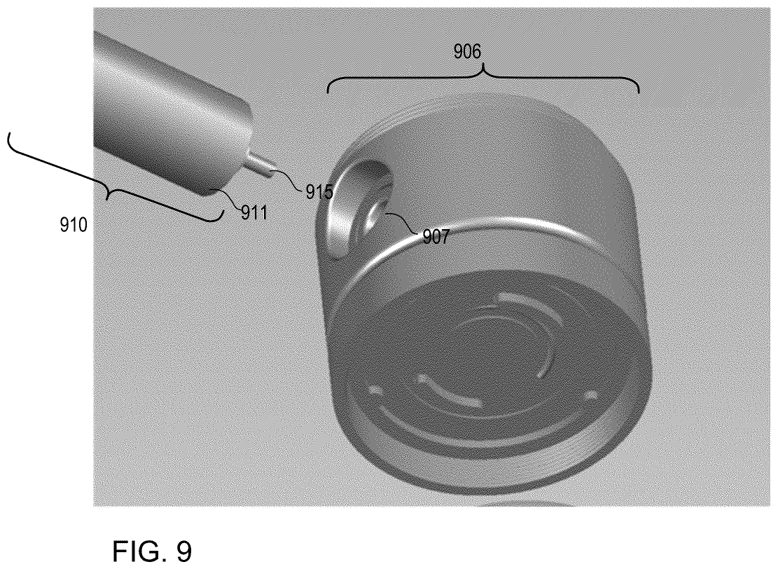

FIG. 9 shows another angle of the light rod 910 and the hub 906 with the connection port on the hub 907 lined up to receive the male connectors 915, 911. This hub may be electrically connected to another hub portion and each pivot respective to one another to allow the connection ports 907 to point in any direction.

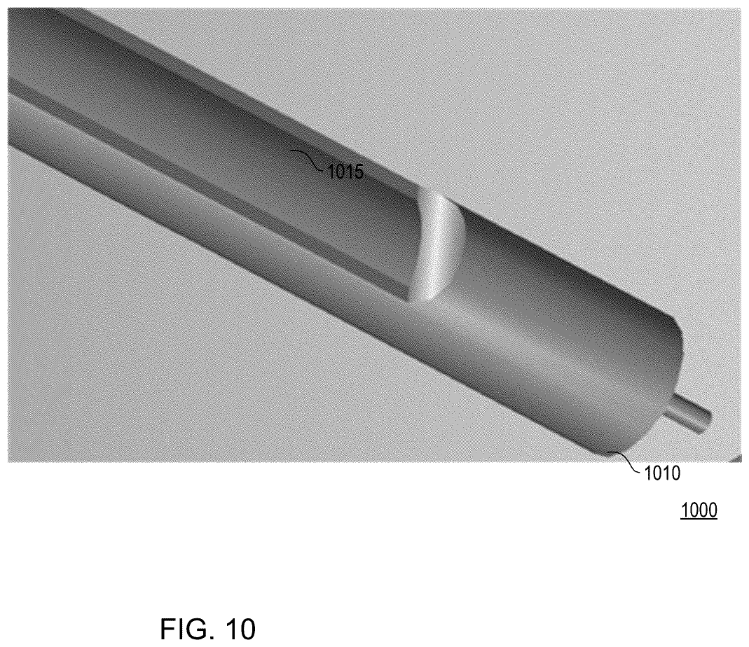

FIG. 10 shows a detail of an optional feature on the light rod 1000 where the periphery of the rod 1010 includes a cut out where a light 1015 may be included or a window to where a light under the window may shine through. Such a light 1015 may be an LED array with an optional cover or diffuser cover mounted into the light rod 1000. In such examples, the electrical connectors (See FIG. 8 815, 813, 811) may connect to the connection port on the hub (not shown in FIG. 10) and power the LED array 1015 in a conventional manner. In some examples, additionally or alternatively, the light rod 1000 does not have any light element in it at all and acts as an electoral conduit from one hub to another as described with wire connections to the next hub. In some examples any number of light portions may be placed on one side, multiple sides, around annularly on the light rod in any kind of combination. Because the light rod 1000 is electrically connected to one or more hubs, any number of lighting arrangements may be configured on the rod, including no light arrangements.

The LED lighting arrangements in the light rod 1000 may be any color, any color temperature, emit any wavelength that might be useful for the implementation in home or office décor. For example, 2700K temperature, 3000K color temperature, or anywhere in between. Examples may include color temperature between 2000K up to 6500K. LEDs may be 3300K color temperature for example. Each arm may be independently controlled on or off and to change dimness, light color, or any other combination or permutation for each independently.

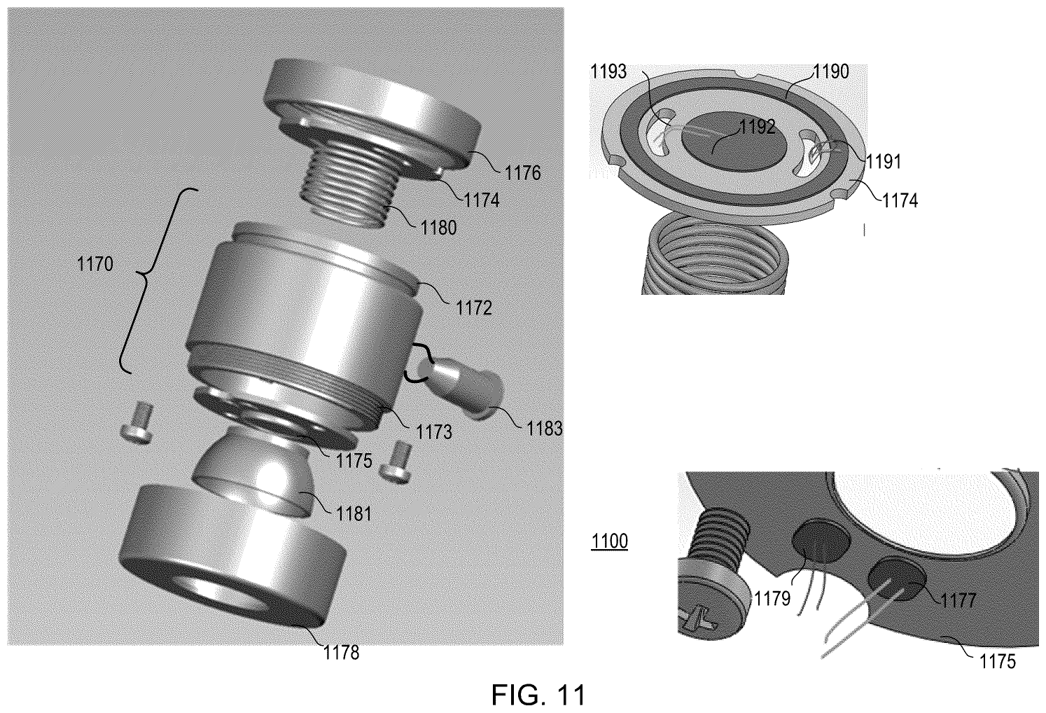

FIG. 11 shows an example hub in exploded view with parts removed. In the example, the hub itself 1100 includes, as previously described, a mounting portion 1176, a top cap 1174 a spring 1180, a main hub body 1170 with a top portion 1172 and a bottom screw portion 1173, a bottom cap 1175 but in this example, the hub itself includes a light assembly 1181 and a bottom cover 1178 that includes an aperture for the light 1181 assembly to shine through. In some examples, additionally or alternatively, 1178 and 1181 are both optical lens choices of any variety or combination. In such examples, the hub 1100 may be connected to other arms which may have their own lighting features in them or not as described herein (arms and connection port not shown in FIG. 11). As shown similarly in FIG. 8, plate 1174 may include the ring of negative connector and center circle for positive connector, so when the main hub body 1170 is assembled with the spring 1180, plate 1174 and screw mounting portion 1176, the electrical connections may be made. In such examples, 1180 spring pushes 1174 onto contact electrical pins (880, 882 in FIG. 8). Such an annular arrangement may keep the electrical connection in place while the parts are screwed together or pivoted relative to one another. In some examples, additionally or alternatively, 1174 has concentric printed circuit boards (PCB) to make electrical contact as shown to control lighting, dimming, color, wireless control or any combination or permutation of computer programmable functions. 1174 has wire soldered to it, and wires connect to 1175, to make electrical connection.

Hub 1100 also shows an example plug 1183 which may be used to fill in a connection port if a rod is not used. 1183 is the back view of Coaxial receptable, is has 2 wires coming out of it to maintain the electrical connection, even if a light arm is not attached to the connection port.

FIG. 11 also shows a detail of 1174 showing the negative electoral connector ring 1190 and positive electrical connector circle 1192. The detail also shows electrical wires 1191 from the negative electrical connector ring and wires 1193 from the positive electrical connector circle 1192 These wires may connect the main hub body 1170 to a power source (not shown) and/or PCB (not shown).

FIG. 11 also shows a detail of 1175 with a positive connector 1177 and wires as well as a negative connector 1179 and wires.

FIG. 12 shows an example hub 1220 which is capable of pivoting around itself to move or position the light rods 1233 and 1235 as described above. In the example, the hub 1220 may be attached to a wall or ceiling by way of screws and anchors 1221. These screws may be mounted inside the hub 122 and hold the hub 1220 to the wall or ceiling (not shown) by screwing into the wall or ceiling using a drywall anchor or other device. Any kind of mounting to a wall or ceiling may be used to secure the hub 1220 and allow for pivoting of the light rods 1233. (FIG. 1 shows these hubs as 120, 130, 140 and FIG. 2 shows these hubs as 220, 230, 240, 250 secured to a wall or ceiling by way of the FIG. 12 anchoring examples.

As shown, each part of the hub 1223 and 1225 with its own connection port and mounted arm 1233 and 1235 is stacked on one another thereby allowing each to pivot or turn up to 360 degrees independently of one another. In such a way, the arms 1233 and 1235 may be positioned in any direction and the electrical connections inside the hub 1220 may be maintained.

FIG. 13 shows another hub, in this example, the main hub that would connect to power on a wall or ceiling. FIG. 1 shows this main hub as 102 and FIG. 2 shows this main hub as 202. This main hub 1302 would mount to the ceiling or wall by mounting bracket 1303 and box 1305 and provide the main power to the various arms 1310 and hubs 1306 with respective lights as described herein.

### CONCLUSION

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the embodiments have been specifically described herein, it will be apparent to those skilled in the art to which the embodiments pertain that variations and modifications of the various implementations shown and described herein may be made without departing from the spirit and scope of the embodiments. Accordingly, it is intended that the embodiments be limited only to the extent required by the applicable rules of law.

What is claimed is:

1. A modular lighting system, comprising:
a hub in communication with a power supply, the hub including a surface anchor unit, a first port and a second port,
wherein the hub first port and hub second port configured to conduct power, and
wherein the hub first port and hub second port configured to pivot relative to each other;
a first bar with a first end and a second end, the first end of the first bar modularly attached to the first hub port by friction fit or magnet;
a second bar with a first end and a second end, the first end of the second bar modularly attached to the second hub port by friction fit or magnet;
a first subhub with a first subhub port configured to conduct power, the first subhub port modularly attached to the second end of the first bar by friction fit or magnet;
a second subhub with a second subhub port configured to conduct power, the second subhub port modularly attached to the second end of the second bar by friction fit or magnet.

2. The system of claim 1 wherein the hub includes an LED light.

3. The system of claim 1 wherein the first subhub includes an LED light powered by the power supply via the first hub port, the first bar, and the first subhub port.

4. The system of claim 3 wherein the second subhub includes an LED light powered by the power supply via the second hub port, the second bar, and the second subhub port.

5. The system of claim 1 wherein the first bar includes an LED light powered by the power supply via the first hub port.

6. The system of claim 5 wherein the second bar includes an LED light powered by the power supply via the second hub port.

7. The system of claim 1 wherein the first subhub includes a surface anchor unit.

8. The system of claim 7 wherein the second subhub includes a surface anchor unit.

9. The system of claim 1 wherein the first light bar includes a nested rod power connection.

10. The system of claim 1 wherein the hub includes a pivotable power connection in the surface anchor unit, configured to allow the hub to pivot relative to the surface and maintain power connection to the power source.

11. The system of claim 10 wherein the hub surface anchor unit includes multiple annular power connections and one central power connection.

12. The system of claim 11 wherein the multiple annular power connections are negative connections and the one central power connection is a positive connection.
